(19) United States
(12) Patent Application Publication
(10) Pub. No.: US 2018/0273849 A1
(43) Pub. Date: Sep. 27, 2018

(54) LTFT CATALYST FINES REMOVAL

(71) Applicants: THE PETROLEUM OIL AND GAS CORPORATION OF SOUTH AFRICA (PTY) LTD, Cape Town (ZA); L'AIR LIQUIDE, SOCIETE ANONYME POUR L'ETUDE ET L'EXPLOITATION DES PROCEDES GEORGES CLAUDE (AIR LI, Paris (FR)

(72) Inventors: Marc BRUESCHKE, Bad Homburg (DE); Manfred RUPPEL, Dietzenbach (DE); Eva Alonso MUSLERA, Mannheim (DE); Pal SORAKER, Trondheim (NO)

(21) Appl. No.: 15/544,474

(22) PCT Filed: Jan. 20, 2016
(86) PCT No.: PCT/ZA2016/050002

§ 371 Date: Jul. 18, 2017

(30) Foreign Application Priority Data
Jan. 20, 2015 (ZA) 2015/00385

(51) Int. Cl. C10G 2/00; B01D 65/08; B01D 63/16

(52) U.S. Cl. CPC C10G 2/32; B01D 65/08; B01D 2319/04; C10G 2300/70; B01D 2321/2033; B01D 63/16

(57) ABSTRACT

The invention provides a method, stage and plant for removing LTFT catalyst fines and/or organometallic catalyst compounds from of LTFT wax, downstream from the LTFT reactor. The method includes at least one stage having the steps of causing a differential pressure across a filter element; causing high mechanical shearing and/or centrifugal forces along and/or away from the surface of the filter on the high pressure side of the filter to cause the particles to be continuously removed from the filter surface; and wherein the differential pressure is selected to be sufficient to force flow of the wax across the filter to cause filtration.

### TECHNICAL FIELD OF THE INVENTION

This invention relates to a method to clean Low Temperature Fischer-Tropsch (LTFT) wax.

### BACKGROUND TO THE INVENTION

The inventor is aware of the presence of fine catalyst particles dispersed in LTFT wax after the wax has been separated from a LTFT reactor. The mixture inside the reactor normally comprises a mixture of hydrocarbons, mostly long chain hydrocarbon wax, gas and suspended solid catalyst particles. The catalyst is normally added to the reactor in a specific size range but, due to attrition the catalyst particle size inside the reactor range in size from its original size to fines. The wax is normally separated from the reactor mixture, including the catalyst by means of internal filters. The required filtration rate is high, which necessitates the filter pore sizes to be to be larger than some of the catalyst fines, which allows for catalyst fines to pass through the filter. Typically the size range from micron to sub-micron sizes and includes organometallic catalyst compounds. These fines cause plugging and/or poisoning of downstream catalysts. High levels of metal fines are also not acceptable for food grade and cosmetic waxes.

Methods to reduce the levels of fines in LTFT wax include catalytic filtering as described in U.S. Pat. No. 7,150,823, acid treatment as described in U.S. Pat. No. 8,022,108, ion exchange treatment as described in US 2005/0004415, hydrothermal treatment to remove oxygenates including some metal oxides as described in WO 2006/005085, growing particles prior to filtration as described in WO 2006/053350, and an external filtration step to trap the fines in a filter mesh as described in EP 2 258 812.

The above methods to reduce the levels of fines in LTFT wax suffer from certain drawbacks. In U.S. Pat. No. 7,150,823 catalytic filtering requires high temperatures up to 600° F. and the exchange of deactivated catalyst. The acid treatment as described in U.S. Pat. No. 8,022,108 requires the use of an additional aqueous process stream and produces a further waste stream. The ion exchange treatment as described in US 2005/0004415 requires regeneration of the ion exchange medium. Hydrothermal treatment to remove oxygenates including some metal oxides as described in WO 2006/005085 and growing particles prior to filtration as described in WO 2006/053350 introduces further chemical agents. The introduction of an external filtration step to trap the fines in a filter mesh as described in EP 2 258 812 requires cleaning of fouled mesh filters.

It is an object of the invention to provide an efficient non-chemical method to remove most of the catalyst fines and organometallic catalyst compounds from LTFT wax, at least to levels below 25 wt-ppm.

### GENERAL DESCRIPTION OF THE INVENTION

According to the invention there is provided a method for removing LTFT catalyst fines and/or organometallic catalyst compounds from of LTFT wax, downstream from the LTFT reactor, which includes at least one stage having the steps of:

causing a differential pressure across a filter element;

causing high mechanical shearing and/or centrifugal forces along and/or away from the surface of the filter on the high pressure side of the filter to cause the particles to be continuously removed from the filter surface; and

wherein the differential pressure is selected to be sufficient to force flow of the wax across the filter to cause filtration.

Apart from turbulent cross flow and lateral shearing forces, centrifugal and centrifugal shearing forces opposite the filter flow direction is useful to move higher density particles away from the filter element, while filter flow of the wax in the opposite direction is maintained by an appropriate transmembrane pressure. The transmembrane pressure is typically between about 1.5 and 6 bar, preferably 1.5-2 bar. The transmembrane pressure is defined as the difference between the filter vessel wax inlet pressure and the cleaned wax outlet pressure minus the centrifugal pressure created by the rotating filter elements.

Typically the required shearing and/or centrifugal forces can be formed by rotating the filter element in the wax mixture.

The filter element may have pores smaller than the fine catalyst particles and organometallic catalyst compounds to be removed.

For each stage, the wax mixture may be fed under pressure into a filter vessel with one or more hollow filter elements extending into the vessel, with the filtrate moving through the filter element out of the vessel.

In a preferred embodiment, the hollow filter elements may be rotated at a high rpm relative to a generally stationary wax mixture.

The filter element may include a hollow cylinder with a porous filter surface or wall and may further have a plurality of circular discs extending perpendicularly from the cylinder and being axially aligned with the cylinder. Each disc may be hollow with the hollow extending from the hollow of the cylinder.

Each stage or vessel may include two or more rotating filter elements arranged such that the discs of adjacent filter elements overlap. The spinning direction of the shafts are preferably in the same direction such that overlapping regions of filter elements move in opposite direction relative to each other to maximise shearing forces and turbulent flow.

In one embodiment, the filter element may have a pore size of between about 20 and 40 nm, typically 30 nm created by TiO₂ coating on a ceramic base.

The permeate from all the stages are collected for further processing.

The stages may be arranged in series with the concentrated wax and catalyst mixture or retentate flowing downstream from one stage to another and finally from the last stage to a catalyst regeneration or processing unit.

The number and sizes of the filter elements or stages are selected by minimizing the overall filter area required for a particular FT wax and its flow rate.

The filtration temperature is typically at about 150° C. with a differential pressure of about 2 bar applied to the filtration vessel.

The invention also extends to a stage unit for removing LTFT catalyst fines and organometallic catalyst compounds from LTFT wax, downstream from the LTFT reactor, which includes:

a filter vessel;

a filter element;

a differential pressure, in use, across a filter element;

a means for causing high mechanical shearing and/or centrifugal forces along and/or away from the surface of the filter on the high pressure side of the filter to cause the particles to be continuously removed from the filter surface; and

wherein the differential pressure is selected to be sufficient to force flow of the wax across the filter to cause filtration.

The invention also extends to a FT wax cleaning plant, downstream from a LTFT reactor, which plant includes at least one stage unit as described above.

### DETAILED DESCRIPTION OF THE INVENTION

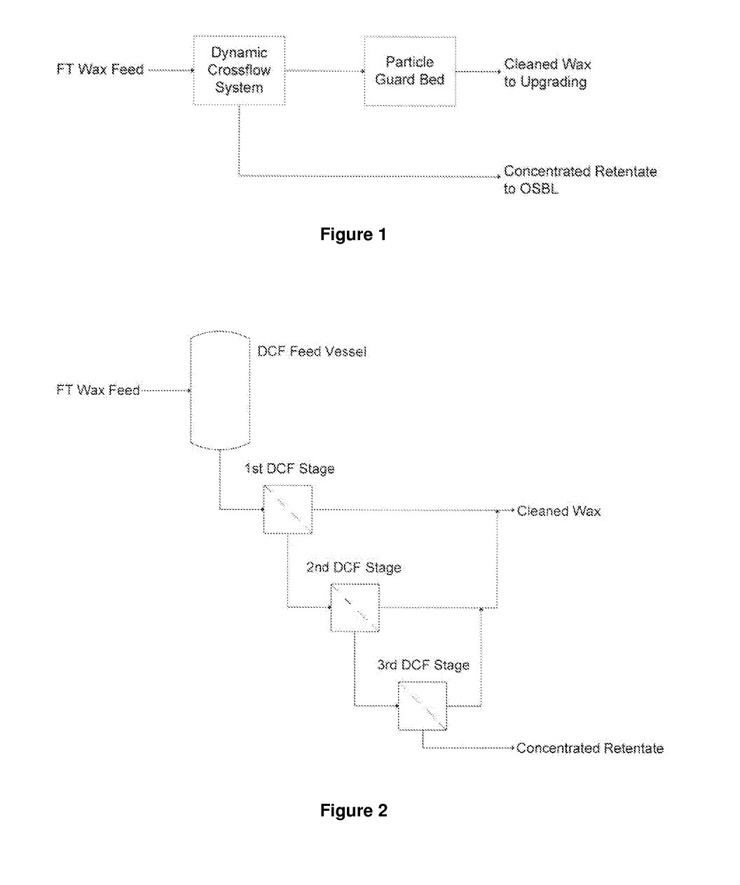

FIG. 1 shows a possible layout of a wax treatment unit which includes a stage unit in accordance with the invention. The wax treatment unit may also include a centrifuge and particle guard beds and other process equipment.

FIG. 2 shows a 3-stage unit, in accordance with the invention.

Experimental trial runs were done on a laboratory scale using one stage of a Dynamic Cross Flow unit. The disc of the unit was rotated at 1200 RPM. The FT wax flow rate was between 0.5 kg/h and 4 kg/h depending on the catalyst concentration in the retentate resulting in a flux range of 15-116 kg/m2·h, with a 30 nm pore size membrane. The total membrane surface area was 0.034 m². The filtration temperature was 150° C. with a pressure of 2 bar applied to the filtration vessel resulting in a transmembrane pressure of 1.8 bar. The test FT wax stream contained 600-750 wt-ppm catalyst. The retentate was concentrated up to 20% mass. A test with permeate recycle keeping the retentate concentration constant at 20% mass was maintained for 14 days. During this test the flux was kept constant at 15 kg/m²·h. No solid particles or catalyst could be detected in the permeate using RFA analysis thereby maintaining a 100% filtration efficiency throughout the test with neither fouling nor abrasion observed.

It shall be understood that the example is provided for illustrating the invention further and to assist a person skilled in the art with understanding the invention and is not meant to be construed as unduly limiting the reasonable scope of the invention.

1. A method for removing LTFT catalyst fines and/or organometallic catalyst compounds from of LTFT wax, downstream from the LTFT reactor, which includes at least one stage having the steps of:
causing a differential pressure across a filter element;
causing high mechanical shearing and/or centrifugal forces along and/or away from the surface of the filter on the high pressure side of the filter to cause the particles to be continuously removed from the filter surface; and
wherein the differential pressure is selected to be sufficient to force flow of the wax across the filter to cause filtration.

2. A method as claimed in claim 1 wherein the transmembrane pressure is between 1.5 and 6 bar.

3. A method as claimed in claim 2 wherein the transmembrane pressure is between 1.5-2 bar.

4. A method as claimed in any one of claims 1 to 3 wherein the shearing and/or centrifugal forces are formed by rotating the filter element in the wax mixture.

5. A method as claimed in any one of claims 1 to 4 wherein the filter element has pores smaller than the fine catalyst particles to be removed.

6. A method as claimed in any one of claims 1 to 5 wherein, for each stage, the wax mixture is fed under pressure into a filter vessel with one or more hollow filter elements extending into the vessel, with the filtrate moving through the filter element out of the vessel.

7. A method as claimed in claim 6, wherein each hollow filter element is rotated at a high rpm relative to a generally stationary wax mixture.

8. A method as claimed in claim 7, wherein the filter element includes a hollow cylinder with a porous filter surface or wall.

9. A method as claimed in claim 8, wherein and further includes a plurality of circular discs extending perpendicularly from the cylinder and being axially aligned with the cylinder with each disc being hollow with the hollow extending from the hollow of the cylinder.

10. A method as claimed in claim 9, wherein each stage or vessel includes two or more rotating filter elements arranged such that the discs of adjacent filter elements overlap and wherein the spinning direction of the shafts are preferably in the same direction such that overlapping regions of filter elements move in opposite direction relative to each other to maximise shearing forces and turbulent flow.

11. A method as claimed in any one of claims 1 to 10 wherein the filter element has a pore size of between 20 and 40 nm created by TiO₂ coating on a ceramic base.

12. A method as claimed in any one of claims 1 to 11 which includes more than one stage and wherein the stages are arranged in series with the concentrated wax and catalyst mixture or retentate flowing downstream from one stage to another and finally from the last stage to a catalyst regeneration or processing unit.

13. A stage for removing LTFT catalyst fines and organometallic catalyst compounds from LTFT wax, downstream from the LTFT reactor, which includes:
a filter vessel;
a filter element;
a differential pressure, in use, across a filter element;
a means for causing high mechanical shearing and/or centrifugal forces along and/or away from the surface of the filter on the high pressure side of the filter to cause the particles to be continuously removed from the filter surface; and
wherein the differential pressure is selected to be sufficient to force flow of the wax across the filter to cause filtration.

14. A Fischer-Tropsch wax cleaning plant, downstream of a LTFT reactor, which plant includes at least one stage as claimed in claim 13.

15. A method for removing LTFT catalyst fines and/or organometallic catalyst compounds from LTFT wax, substantially as described herein with reference to the accompanying drawings.

16. A stage for removing LTFT catalyst fines and/or organometallic catalyst compounds from LTFT wax, substantially as described herein with reference to the accompanying drawings.

17. A Fischer-Tropsch wax cleaning plant, substantially as described herein with reference to the accompanying drawings.
